(19) United States
(12) Patent Application Publication
(10) Pub. No.: US 2025/0102429 A1
(43) Pub. Date: Mar. 27, 2025

(54) OPTICAL MEMBER, OPTICAL ELEMENT AND METHOD FOR PRODUCING OPTICAL MEMBER

(71) Applicant: HAMAMATSU PHOTONICS K.K., Hamamatsu-shi, Shizuoka (JP)

(72) Inventors: Kouichiro AKIYAMA, Hamamatsu-shi, Shizuoka (JP); Hiroshi SATOZONO, Hamamatsu-shi, Shizuoka (JP)

(73) Assignee: HAMAMATSU PHOTONICS K.K., Hamamatsu-shi, Shizuoka (JP)

(21) Appl. No.: 18/725,845

(22) PCT Filed: Dec. 2, 2022
(86) PCT No.: PCT/JP2022/044586

§ 371 Date: Jul. 1, 2024

(30) Foreign Application Priority Data
Jan. 7, 2022 (JP) 2022-001664

(51) Int. Cl. G01N 21/3581

(52) U.S. Cl. CPC G01N 21/3581

(57) ABSTRACT

There is provided an optical member for terahertz. The optical member is constituted by a molded body containing a mixture of an organic nonlinear optical material and an excipient. There is also provided an optical element including: the optical member; and a support member configured to support the optical member. There is also provided a method for manufacturing an optical member for terahertz. The method includes: a first process of mixing an organic nonlinear optical material and an excipient to form a mixture; and a second process of forming a molded body of the mixture by applying a pressure to the mixture after the first process.

### TECHNICAL FIELD

The present disclosure relates to an optical member, an optical element, and a method for manufacturing an optical member.

### BACKGROUND ART

Patent Literature 1 discloses a particle-shaped composition that contains porous particle-shaped silicon oxide as a main component, and a terahertz wave emitting compound capable of emitting terahertz waves.

### CITATION LIST

### Patent Literature

Patent Literature 1: Japanese Unexamined Patent Publication No. 2018-104289

### SUMMARY OF INVENTION

### Technical Problem

Currently, there is a demand for an optical member capable of generating and detecting high-intensity and broadband terahertz waves. As an example of the optical member, for example, there is a plate-shaped optical member that is obtained by crystallizing an organic nonlinear optical material such as DAST (4-N,N-Dimethyl-Amino-4′-N′-methyl-Stilbazolium 4-Toluenesulfonate). According to the optical member, it is possible to efficiently generate and detect the terahertz waves. However, the organic nonlinear optical material for generating the terahertz waves is generally extremely expensive because the crystallization requires time and effort and a yield ratio thereof is also low.

Here, an object of the present disclosure is to provide an optical member with which terahertz waves can be generated and detected and a yield ratio can be improved while suppressing the cost, an optical element, and a method for manufacturing an optical member.

### Solution to Problem

An optical member according to the present disclosure is an optical member for terahertz. The optical member is constituted by a molded body containing a mixture of an organic nonlinear optical material and an excipient.

The optical member is constituted by the molded body containing the mixture of the organic nonlinear optical material and the excipient. According to findings obtained by the present inventors, the molded body can generate and detect terahertz waves as in an optical member obtained by crystallizing the organic nonlinear optical material. On the other hand, this optical member saves the trouble of crystallizing the organic nonlinear optical material into a single member, it is possible to improve a yield ratio while suppressing the cost.

In the optical member according to the present disclosure, the mixture may partially contain crystals of the organic nonlinear optical material. In this way, the optical member may partially contain crystals generated, for example, during synthesis of the organic nonlinear optical material, and the like. Even in this case, for example, as compared with a case in which the organic nonlinear optical material is synthesized and then crystallized to form the single member, it is possible to improve a yield ratio while suppressing the cost.

In the optical member according to the present disclosure, the excipient may contain polyethylene and/or Teflon (registered trademark). In this way, when using polyethylene or Teflon as the excipient, formation of the molded body becomes easy.

In the optical member according to the present disclosure, the optical member may emit terahertz waves when being irradiated with laser light. Alternatively, the optical member may be irradiated with terahertz waves and detect the terahertz waves. In this way, the optical member according to the present disclosure can be used in emission or detection of terahertz waves.

An optical element according to the present disclosure may include the above-described optical member and a support member configured to support the optical member. In this case, handling of the optical member is easy.

In the optical element according to the present disclosure, the support member may be formed in an annular shape so as to support a peripheral edge portion of the optical member while exposing a central portion of the optical member. In this case, it is possible to use a portion exposed from the support member in the optical member as a light incident/emitting portion while making handling of the optical member easy.

In the optical element according to the present disclosure, the support member may be a lens, and the optical member may be provided on a light incident surface or light emitting surface of the lens. In this case, it is possible to condense light incident to the optical member by the lens or suppress spreading of light emitted from the optical member by the lens while making handing of the optical member easy.

The optical element according to the present disclosure may further include a moisture-proof film provided on a surface of the optical member. In this case, deliquescence of the optical member is suppressed.

A method for manufacturing an optical member according to the present disclosure is a method for manufacturing an optical member for terahertz. The method includes a first process of mixing an organic nonlinear optical material and an excipient to form a mixture, and a second process of forming a molded body of the mixture by applying a pressure to the mixture after the first process.

In the method for manufacturing this optical member, after forming a mixture of the organic nonlinear optical material and the excipient, a pressure is applied to the mixture to form a molded body. According to findings obtained by the present inventors, the molded body can generate and detect terahertz waves as in an optical member obtained by crystallizing the organic nonlinear optical material. On the other hand, in the method for manufacturing the optical member, since a process of crystallizing the organic nonlinear optical material into a single member can be omitted, it is possible to improve a yield ratio while suppressing the cost.

The method for manufacturing an optical member according to the present disclosure may further include a third process of crystallizing at least a part of the organic nonlinear optical material before the first process. In this way, in the method for manufacturing this optical member, for example, a partial crystallization process such as synthesis of the organic nonlinear optical material may be included. Even in this case, for example, as compared with a case of performing a process of synthesizing and crystallizing the organic nonlinear optical material to form a single member, it is possible to improve a yield ratio while suppressing the cost.

### Advantageous Effects of Invention

An object of the present invention is to provide an optical member with which terahertz waves can be generated and detected and a yield ratio can be improved while suppressing the cost, an optical element, and a method for manufacturing an optical member.

### BRIEF DESCRIPTION OF DRAWINGS

FIG. 1 is a schematic view illustrating a terahertz wave measurement device according to an embodiment.

FIG. 2 is a plan view illustrating a terahertz wave generation element as an optical element illustrated in FIG. 1.

FIG. 3 is a graph illustrating optical characteristics of an optical member illustrated in FIG. 2.

FIG. 4 is a graph illustrating comparison between a DASC crystal as a comparative example and the optical member according to this embodiment.

FIG. 5 is a graph illustrating a time waveform of terahertz waves when rotating the optical member.

FIG. 6 is a graph illustrating a relationship between a particle size of an excipient and optical characteristics in the optical member.

FIG. 7 is a graph for comparing optical characteristics between a case where the excipient is used and a case where the excipient is not used.

FIG. 8 is a flowchart illustrating a process of a method for manufacturing the optical member according to this embodiment.

FIG. 9 is a graph illustrating optical characteristics of an optical member containing an organic nonlinear optical material expressed by Expression (3).

FIG. 10 is a graph illustrating optical characteristics of an optical member containing an organic nonlinear optical material expressed by Expression (4).

### DESCRIPTION OF EMBODIMENTS

Hereinafter, an embodiment according to the present disclosure will be described in detail with reference to the drawings. Note that, in description of the drawings, the same reference numerals will be given to the same or equivalent drawings, and redundant description may be omitted.

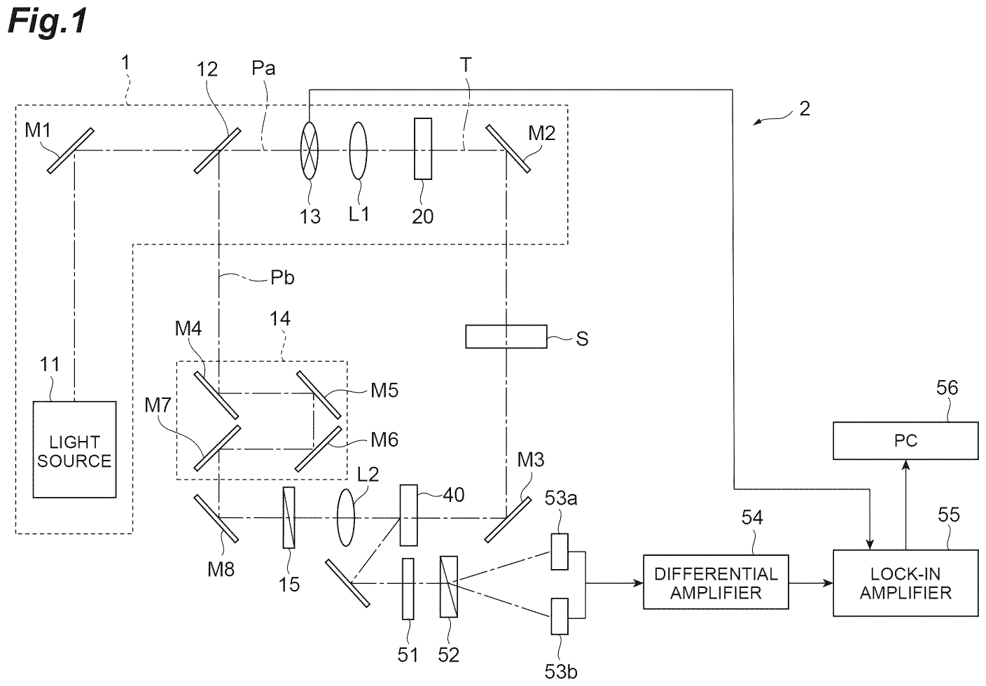

FIG. 1 is a schematic view illustrating a terahertz wave measurement device according to the embodiment. A terahertz wave measurement device 2 illustrated in FIG. 1 acquires information of a measurement object S by a transmission measurement method by using terahertz waves. The terahertz wave measurement device 2 includes a light source 11, a branching portion 12, a chopper 13, an optical path length difference adjustment portion 14, a polarizer 15, a terahertz wave generation element (optical element) 20, a terahertz wave detection element (optical element) 40, a ¼ wavelength plate 51, a polarization separation element 52, a photodetector 53a, a photodetector 53b, a differential amplifier 54, and a lock-in amplifier 55.

The light source 11 outputs pulsed light beams at a constant repetition cycle, and may be, for example, a femtosecond pulsed laser beam source that outputs pulsed laser light having a pulse width of approximately femtoseconds. A wavelength of the light beams output from the light source 11 may be, for example, 700 to 1600 nm.

The branching portion 12 is, for example, abeam splitter, branches the pulsed light beams that are output from the light source 11 and are incident through a mirror M1 into two parts, outputs one pulsed light beam between two branched pulsed light beams to the terahertz wave generation element 20 side as a pump light beam Pa, and outputs the other pulsed light beam to a mirror M4 side as a probe light beam Pb.

The chopper 13 is provided on an optical path of the pump light beam Pa between the branching portion 12 and the terahertz wave generation element 20, and alternately repeats passing and blocking of the pump light beam Pa at a constant cycle. The pump light beam Pa that is output from the branching portion 12 and passes through the chopper 13 is input to the terahertz wave generation element 20 through a lens L1. The lens L1 condenses the pump light beam Pa toward the terahertz wave generation element 20. An optical system of the pump light beam until reaching the terahertz wave generation element 20 from the branching portion 12 may be referred to as “pump optical system” below.

The terahertz wave generation element 20 generates and outputs a pulsed terahertz wave T when the pump light beam Pa is input thereto. The pulsed terahertz wave T is generated at a constant repetition cycle, and a pulse width is approximately several picoseconds. The pulsed terahertz wave T generated by the terahertz wave generation element 20 is reflected from a first paraboloid of a mirror M2 to be parallel light and is emitted to the measurement object S. The pulsed terahertz wave T transmitted through the measurement object S is condensed toward the terahertz wave detection element 40 while being condensed by a second paraboloid of a mirror M3. Note that, the terahertz wave generation element 20 may be another electrooptical crystal, and the optical element according to the invention can be employed to at least one of the terahertz wave generation element 20 and the terahertz wave detection element 40.

In the terahertz wave measurement device 2, the terahertz wave generation device 1, of which the terahertz wave generation device 1 is composed, including the light source 11, the branching portion 12, the chopper 13, the lens L1, the mirror M1, the mirror M2, and the terahertz wave generation element 20 in the pump optical system includes the light source 11 and the terahertz wave generation element 20, the pulsed light beams output from the light source 11 may be input to the terahertz wave generation element 20, and the other configurations of the terahertz wave generation device 1 are any configurations.

In the terahertz wave measurement device 2, the pulsed terahertz wave T transmitted through the measurement object S is detected by the terahertz wave detection element 40. In addition, a signal in a case where the measurement object S is not disposed is set as a reference signal, and a signal transmitted through the measurement object S is analyzed as a measurement signal to detect information (for example, an absorption coefficient and a refractive index) of the measurement object S. As the terahertz wave, an electromagnetic wave having a frequency in a range of approximately 0.01 THz to 100 THz can be assumed as an example.

Here, the probe light beam Pb output from the branching portion 12 is sequentially reflected by mirrors M4 to M8 and passes through the polarizer 15. The probe light beam Pb that has passed through the polarizer 15 is input to the terahertz wave detection element 40 through a lens L2. The lens L2 condenses the probe light beam Pb toward the terahertz wave detection element 40. The four mirrors M4 to M7 constitute the optical path length difference adjustment portion 14.

In the terahertz wave detection element 40, a correlation between the pulsed terahertz wave T and the probe light beam Pb is detected. The terahertz wave detection element 40 may contain other electrooptical crystals.

The polarization separation element 52, to which the probe light beam Pb output from the terahertz wave detection element 40 and passed through the ¼ wavelength plate 51 is input, separates the input probe light beam Pb into two polarization components orthogonal to each other and outputs the polarization components. For example, the polarization separation element 52 may be a Wollaston prism. The photodetectors 53a and 53b include, for example, a photodiode, detect the power of the two polarization components of the probe light beam Pb polarized and separated by the polarization separation element 52, and output an electrical signal of a value corresponding to the detected power to the differential amplifier 54.

The differential amplifier 54, to which the electrical signal output from each of the photodetectors 53a and 53b is input, outputs an electrical signal having a value corresponding to a difference between values of both electrical signals to the lock-in amplifier 55. The lock-in amplifier 55 synchronously detects the electrical signal output from the differential amplifier 54 at a repetition frequency of passing and blocking of the pump light beam in the chopper 13. A signal output from the lock-in amplifier 55 has a value depending on an electric field intensity of terahertz waves. In this way, a correlation between the pulsed terahertz wave T transmitted through the measurement object S and the probe light beam Pb is detected, and an electric field amplitude of the pulsed terahertz wave T is detected to obtain information of the measurement object S. An output of the lock-in amplifier 55 is provided to PC 56 that is any computer.

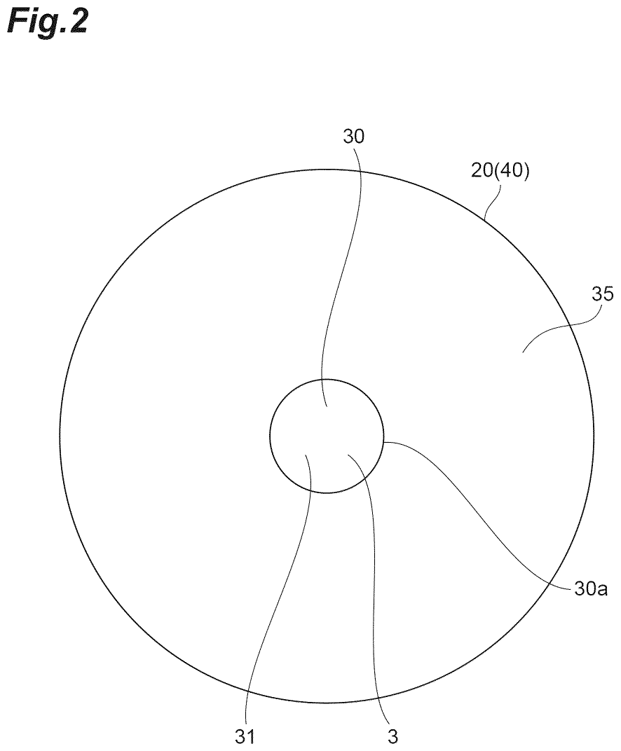

FIG. 2 is a plan view illustrating the terahertz wave generation element as the optical element shown in FIG. 1. The terahertz wave generation element 20 illustrated in FIG. 2 includes an optical member 30 for terahertz and a support member 35 that supports the optical member 30. For example, the optical member 30 is a molded body that is molded as a plate-shaped (here, disk-shaped) pellet. The support member 35 has an annular shape in a plan view (that is, when viewed in an optical axis direction of the pump light beam Pa), and supports a peripheral edge portion 30a of the optical member 30. More specifically, the support member 35 is formed in an annular shape, for example, by a metal, and an inner surface thereof is in contact with the peripheral edge portion 30a of the optical member 30 to support the optical member 30. Accordingly, here, the support member 35 supports the optical member 30 while exposing the entirety of the light incident/emitting surface including a central portion of the optical member 30. Note that, a shape of the optical member 30 in a plan view is not limited to a circular shape, and may be a polygonal shape such as a rectangular shape and a triangular shape. Even in a case where the shape of the optical member 30 is the circular shape in a plan view, this case is preferable because it is easy to uniformly apply a pressure to the entirety of a pellet when manufacturing the pellet as described later.

The optical member 30 is irradiated with the pump light beam Pa that is a laser beam, and emits terahertz waves. Note that, the terahertz wave detection element 40 shown in FIG. 1 can also have a similar configuration. In this case, the optical member 30 is irradiated with the terahertz waves and detects the terahertz waves.

The optical member 30 contains an organic nonlinear optical material 31 and an excipient 32. The organic nonlinear optical material 31 is any material that has a high secondary nonlinear optical constant, generates high-intensity terahertz waves, and that can generate and detect broadband terahertz waves. As an example, the organic nonlinear optical material 31 is DAST (4-dimethylamino-N-methyl-4-stilbazolium tosylate) expressed by the following Formula (1) or DASC (4-dimethylamino-N-methyl-4-stilbazolium p-chlorobenzene sulfonate) expressed by following Formula (2).

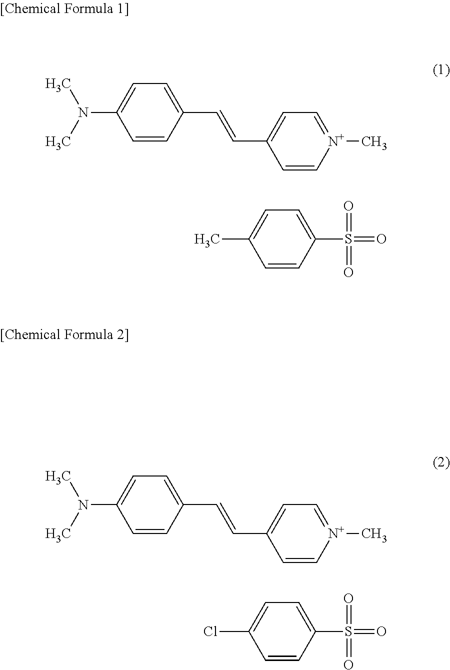

On the other hand, the excipient 32 contains, for example, polyethylene and/or Teflon. The optical member 30 is constituted by a molded body containing a mixture of the above-described organic nonlinear optical material 31 and the excipient 32. The mixture of the organic nonlinear optical material 31 and the excipient 32 shows a state in which particles of the organic nonlinear optical material 31 are (mechanically and physically) dispersed in particles of the excipient 32.

Although a specific manufacturing method will be described later, the optical member 30 is obtained by synthesizing an organic nonlinear optical material, preparing a mixture by mixing the organic nonlinear optical material and an excipient, and press-molding the mixture into a pellet shape. That is, the optical member 30 can be obtained by manufacturing without growing the organic nonlinear optical material into a plate-shaped crystal having a desired size. Note that, the optical member 30 may partially contain crystals of the organic nonlinear optical material.

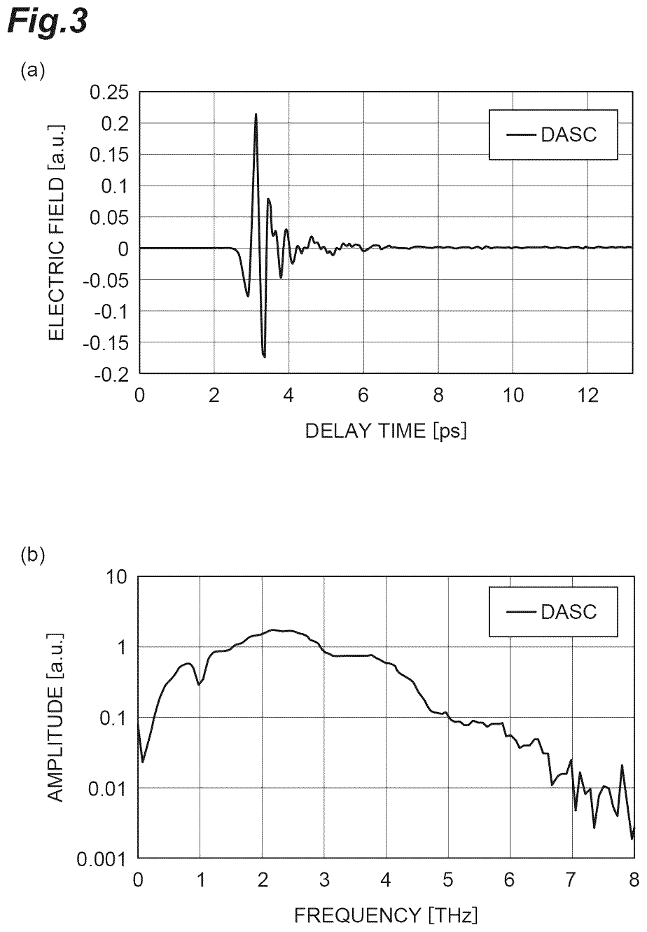

FIG. 3 is a graph illustrating optical characteristics of the optical member illustrated in FIG. 2. (a) of FIG. 3 is a time waveform of terahertz waves emitted from the optical member 30, and (b) of FIG. 3 illustrates a spectrum of the terahertz waves emitted from the optical member 30. In an example of FIG. 3 to FIG. 5, DASC (25 wt %) is used as the organic nonlinear optical material, and polyethylene (75 wt %) is used as the excipient. As illustrated in FIG. 3, according to the optical member 30 that is a molded body of a mixture of DASC and polyethylene, emission of broadband terahertz waves is confirmed. Note that, a weight ratio of the organic nonlinear optical material in the optical member 30 may be 10 wt % or more and 50 wt % or less, or 20 wt % or more and 30 wt % or less.

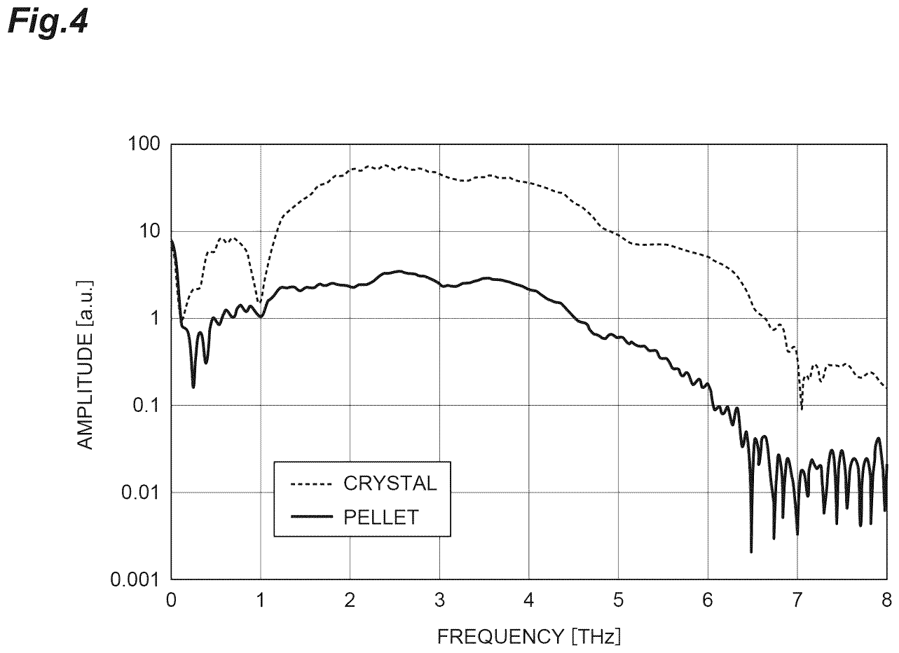

FIG. 4 is a graph illustrating comparison between a DASC crystal as a comparative example and the optical member according to this embodiment. As illustrated in FIG. 4, according to the optical member 30 according to this embodiment, although the optical member 30 shows a decrease in a signal as compared with the DASC crystal, it is understood that a usable sufficient SN ratio is secured, and broadband characteristics comparable to the DASC crystal are secured.

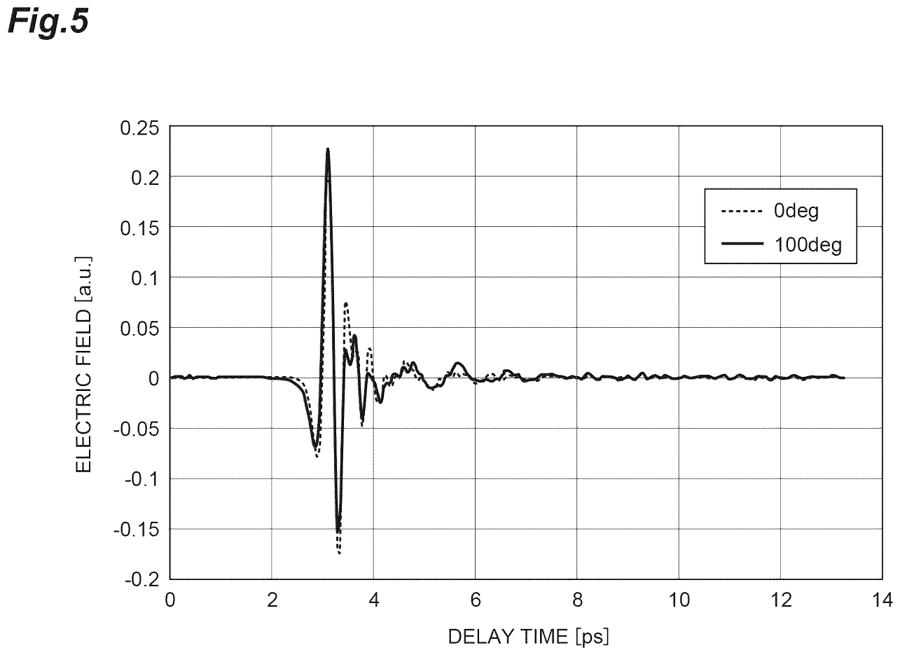

FIG. 5 is a graph illustrating a time waveform of terahertz waves when rotating the optical member. 0 deg shown in FIG. 5 represents a value that becomes a reference, and 100 deg represents a value when rotating the optical member around the optical axis of the pump light beam Pa by 100°. As illustrated in FIG. 5, according to the optical member 30, angle dependence of the signal intensity is not recognized, and it is considered that polarization of the emitted terahertz waves can be simply controlled without crystal rotation by controlling polarization of the pump light beam Pa.

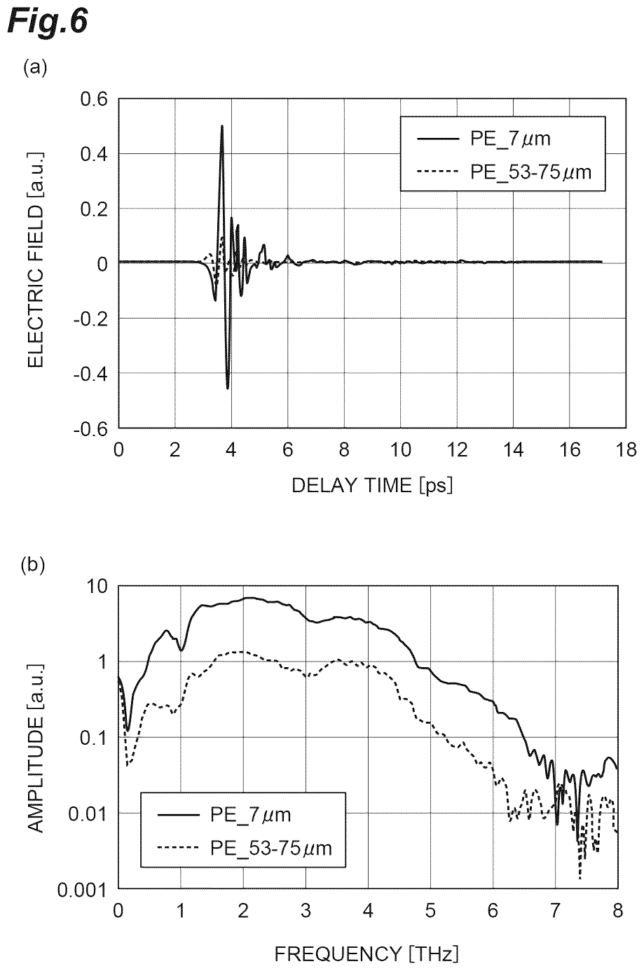

Note that, a particle size of the excipient in the optical member 30 is any size, but the particle size of the excipient can have an influence on the optical characteristics. FIG. 6 is a graph illustrating a relationship between the particle size of the excipient and the optical characteristics in the optical member. (a) of FIG. 6 represents a time waveform of the terahertz waves emitted from the optical member 30, and (b) of FIG. 6 represents a spectrum of the terahertz waves emitted from the optical member 30. As illustrated in FIG. 6, in a case where the particle size of polyethylene as the excipient is as relatively small as 7 μm, a stronger signal is obtained as compared with a case where the particle size is mixed in a range of 53 μm to 75 μm and is relatively large. The reason for this is considered because a surface of the optical member 30 becomes smoother (mirror finished) due to the small particle size of polyethylene, and an influence of light scattering on the surface is reduced.

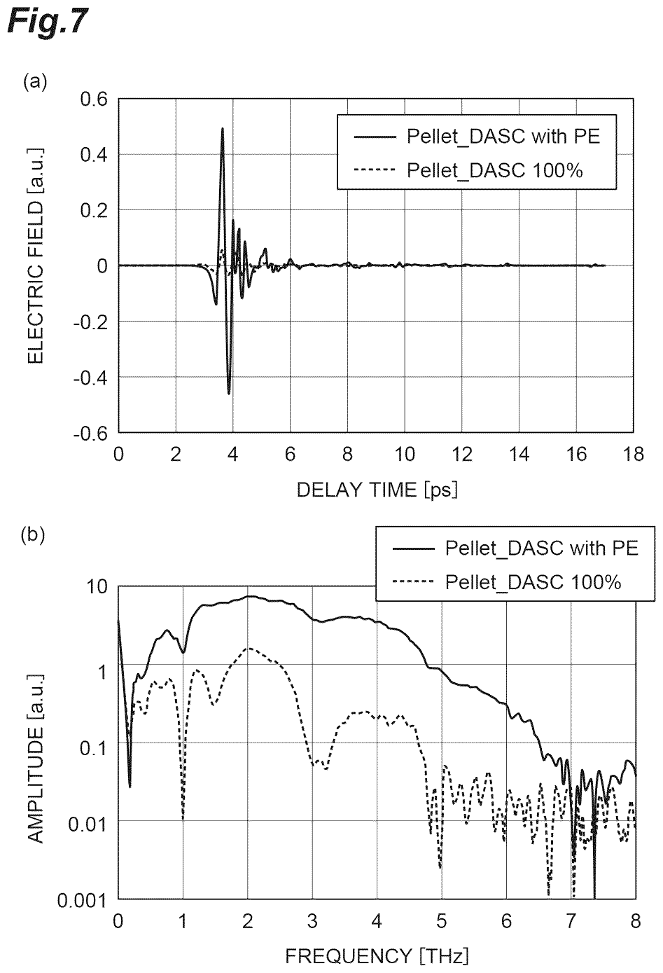

In addition, it is typically known that the excipient such as polyethylene scatters terahertz waves, and thus transmittance of the terahertz waves is reduced particularly in a high frequency range. Therefore, in the related art, no attempt has been made to use a molded body of a mixture with an excipient such as polyethylene as an optical member that is used for generating and detecting the broadband terahertz waves. In contrast, as illustrated in FIG. 7, according to the present inventors, in a case where the optical member 30 is constituted by the molded body of the mixture of the organic nonlinear optical material and polyethylene (Pellet_DASC with PE in FIG. 7), it was confirmed that output of the terahertz waves is stronger as compared with a case where polyethylene is not used (Pellet_DASC 100% in FIG. 7).

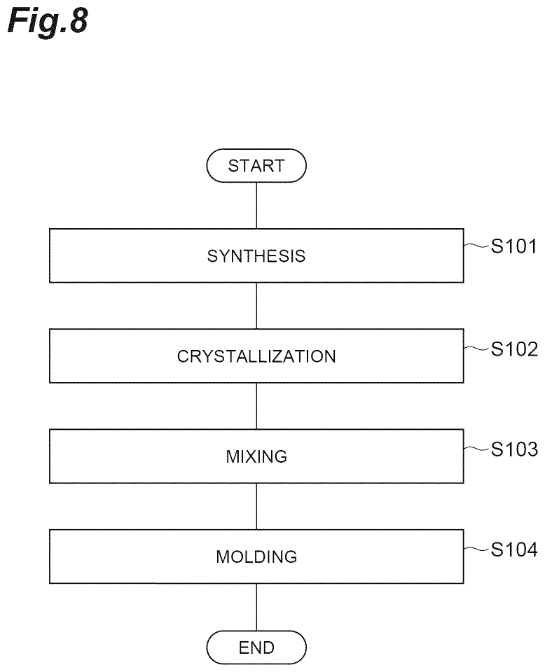

Next, a method for manufacturing the optical member 30 according to this embodiment will be described. FIG. 8 is a flowchart illustrating a process of the method for manufacturing the optical member according to this embodiment. As illustrated in FIG. 8, first, the organic nonlinear optical material is synthesized (process S101). At this time, crystals of the organic nonlinear optical material can be generated. Next, crystallization of the organic nonlinear optical material obtained in the process S101 is performed (process S102: third process). In the process S102, it is not necessary to form high-quality plate-shaped crystals having a desired size from the organic nonlinear optical material as in the related art, and it is sufficient to crystallize at least a part of the organic nonlinear optical material. In addition, the process S102 may be omitted.

Next, a mixture of the organic nonlinear optical material obtained in the processes S101 and S102 and the excipient is formed (process S103, first process). Specifically, the organic nonlinear optical material obtained in the processes S101 and S102 and particles of the excipient are put into a mortar and are mixed to obtain the mixture.

Then, a pressure is applied to the mixture obtained in the process S103 to form a molded body of the mixture (process S104, second process). More specifically, in the process S104, the mixture obtained in the process S103 is disposed inside the support member 35, and is pressed in a vertical direction with a 2 T press. According to this, for example, a pellet-shaped molded body having a size of a diameter of approximately 7 mm and a thickness of approximately 200 μm is obtained. The obtained molded body is set as the optical member 30 and can be used as the terahertz wave generation element 20 and/or the terahertz wave detection element 40 in combination with the support member 35 (without being removed from the support member 35). Note that, the size of the molded body (optical member 30) stated here can be set to, for example, a diameter of approximately 5 mm to 20 mm, and a thickness of approximately 0.1 mm to 0.5 mm.

As described above, the optical member 30 according to this embodiment is constituted by the molded body of the mixture of the organic nonlinear optical material 31 and the excipient 32. According to the findings obtained by the present inventors, the molded body can generate and detect terahertz waves as in an optical member obtained by crystallizing the organic nonlinear optical material. On the other hand, this optical member 30 saves the trouble of crystallizing the organic nonlinear optical material into a single member (forming high-quality crystals), and it is not limited by the quality of the crystals, it is possible to improve a yield ratio while suppressing the cost.

In addition, in the optical member 30 according to this embodiment, the mixture may partially contain crystals of the organic nonlinear optical material 31. In this way, the optical member 30 may partially contain crystals generated, for example, during synthesis of the organic nonlinear optical material 31, and the like. Even in this case, for example, as compared with a case in which the organic nonlinear optical material 31 is synthesized and then crystallized to form the single member, it is possible to improve a yield ratio while suppressing the cost.

In addition, In the optical member 30 according to this embodiment, the excipient 32 may contain polyethylene and/or Teflon. In this way, when using polyethylene or Teflon as the excipient 32, formation of the molded body becomes easy.

In addition, the optical member 30 according to this embodiment can be used in the terahertz wave generation element 20 that is irradiated with a laser beam (pump light beam Pa) and emits the pulsed terahertz wave T, or the terahertz wave detection element 40 that is irradiated with the pulsed terahertz wave T and detects the pulsed terahertz wave T. In this way, the optical member 30 according to this embodiment may be used for emission or detection of the pulsed terahertz wave T.

In addition, the terahertz wave generation element 20 and/or the terahertz wave detection element 40 according to this embodiment include the above-described optical member 30, and the support member 35 that supports the optical member 30. Therefore, handling of the optical member 30 becomes easy.

Furthermore, in the terahertz wave generation element 20 and/or the terahertz wave detection element 40 according to this embodiment, the support member 35 may be formed in an annular shape so as to support the peripheral edge portion 30a of the optical member 30 while exposing the central portion of the optical member 30. According to this, it is possible to use a portion exposed from the support member 35 in the optical member 30 as a light incident/emitting portion while making handling of the optical member 30 easy.

The above-described embodiment describes an aspect of the present disclosure. Accordingly, the present disclosure can be modified in any manner without being limited to the above-described embodiment. Next, a modification example will be described.

First, in the above-described embodiment, as the organic nonlinear optical material 31 that can be used in the optical member 30, DAST expressed by Formula (1), and DASC expressed by Formula (2) have been exemplified. However, in the optical member 30, instead of the materials, a material (organic nonlinear optical material) expressed by Formula (3) can be used. In the material expressed by Formula (3), terahertz waves are difficult to be generated by crystallization. In other words, the material expressed by Formula (3) is a material in which crystal capable of emitting terahertz waves are difficult to be created.

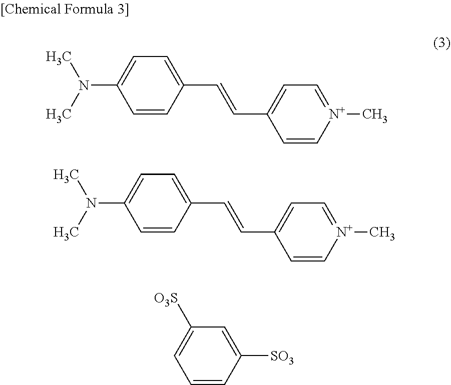

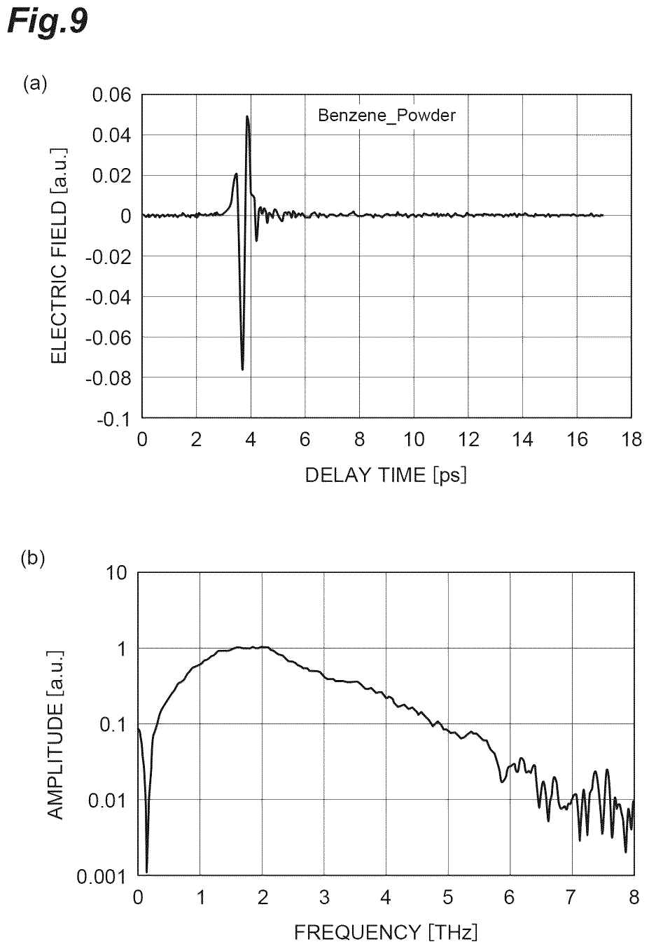

FIG. 9 is a graph illustrating optical characteristics of an optical member containing the organic nonlinear optical material expressed by Formula (3). (a) of FIG. 9 illustrates a time waveform of terahertz waves emitted from the optical member 30 using the organic nonlinear optical material expressed by Formula (3), and (b) of FIG. 9 illustrates a spectrum of the terahertz waves emitted from the optical member 30. As illustrated in FIG. 9, even in the material expressed by Formula (3) in which crystals capable of emitting the terahertz waves are difficult to be created, when constituting the optical member 30 as a molded body (pellet) of a mixture with an excipient, it was confirmed that the optical member 30 can be an emission source of the terahertz waves (and a detection element of the terahertz waves). Note that, here, after synthesizing and drying the material expressed by Formula (3), a green microcrystalline powder is pelletized and a terahertz wave emission test is conducted.

Similarly, in the optical member 30, instead of DAST or DASC, a material (organic nonlinear optical material) expressed by Formula (4) can be used.

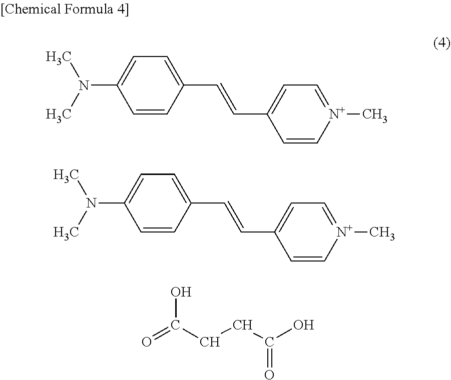

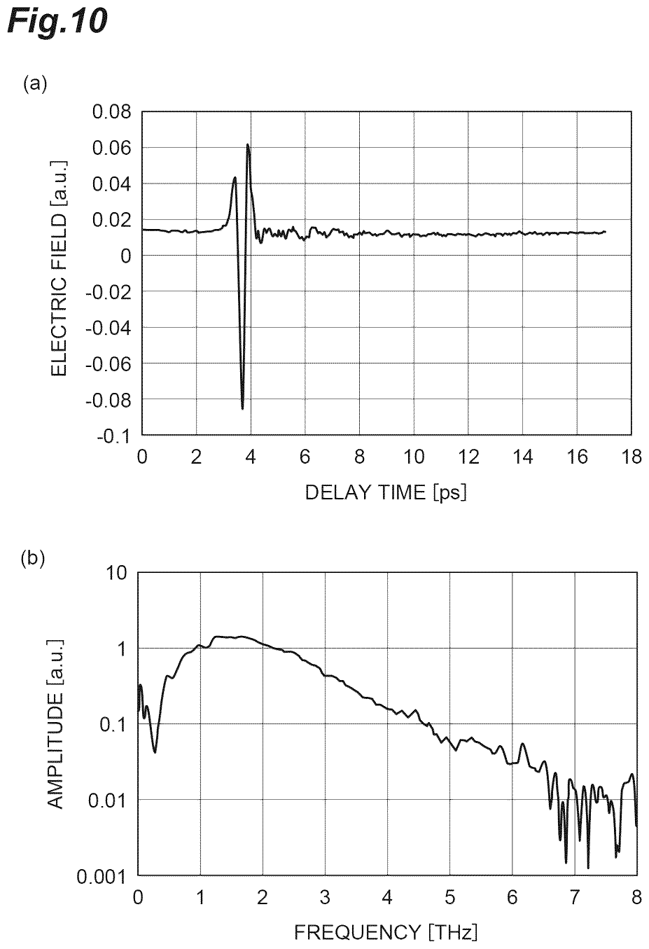

FIG. 10 is a graph illustrating optical characteristics of an optical member containing the organic nonlinear optical material expressed by Formula (4). (a) of FIG. 10 illustrates a time waveform of terahertz waves emitted from the optical member 30 using the organic nonlinear optical material expressed by Formula (4), and (b) of FIG. 10 illustrates a spectrum of the terahertz waves emitted from the optical member 30. As illustrated in FIG. 10, even in the material expressed by Formula (4), when constituting the optical member 30 as a molded body (pellet) of a mixture with an excipient, it was confirmed that the optical member 30 can be an emission source of the terahertz waves (and a detection element of the terahertz waves. Note that, here, after synthesizing and drying the material expressed by Formula (4), a green microcrystalline powder is pelletized and a terahertz wave emission test is conducted.

Note that, in the above-described embodiment, description has been given of an aspect in which as the terahertz wave generation element 20 and/or the terahertz wave detection element 40, the optical member 30 is supported by using the support member 35 having an annular shape (capable of being used in a press machine). However, the support member of the optical member 30 is not limited thereto. For example, as the support member of the optical member 30, a lens can be used. In this case, when providing the optical member 30 on a light incident surface or a light emission surface of the lens, the optical member 30 can be supported by the lens. When providing the optical member 30 on the light incident surface of the lens, spreading of the pulsed terahertz wave T emitted from the optical member 30 can be suppressed by the lens. In addition, when providing the optical member 30 on the light emission surface of the lens, incident light beams to the optical member 30 can be condensed by the lens.

In addition, a transparent substrate or the like may be used as the support member instead of the lens. Furthermore, the support member may not be used.

In addition, it is possible to use a mixture of organic nonlinear optical crystal grains and an excipient which are purified by dissolving the organic nonlinear optical material in a solvent (such as methanol) and precipitating the organic nonlinear optical material.

Furthermore, a moisture-proof film may be provided on a surface of the optical member 30. In this case, deliquescence of the optical member can be suppressed.

### INDUSTRIAL APPLICABILITY

There are provided an optical member with which terahertz waves can be generated and detected and a yield ratio can be improved while suppressing the cost, an optical element, and a method for manufacturing an optical member.

### REFERENCE SIGNS LIST

20: terahertz wave generation element (optical element), 30: optical member, 30a: peripheral edge portion, 31: organic nonlinear optical material, 32: excipient, 35: support member, 40: terahertz wave detection element (optical element).

1: An optical member for terahertz constituted by a molded body containing a mixture of an organic nonlinear optical material and an excipient.

2: The optical member according to claim 1, wherein the mixture partially contains crystals of the organic nonlinear optical material.

3: The optical member according to claim 1, wherein the excipient contains polyethylene and/or Teflon.

4: The optical member according to claim 1,
wherein the optical member emits terahertz waves when being irradiated with laser light.

5: The optical member according to claim 1,
wherein the optical member is irradiated with terahertz waves and detects the terahertz waves.

6: An optical element, comprising:
the optical member according to claim 1; and
a support member configured to support the optical member.

7: The optical element according to claim 6,
wherein the support member is formed in an annular shape so as to support a peripheral edge portion of the optical member while exposing a central portion of the optical member.

8: The optical element according to claim 6,
wherein the support member is a lens, and
the optical member is provided on a light incident surface or light emitting surface of the lens.

9: The optical element according to claim 6, further comprising:
a moisture-proof film provided on a surface of the optical member.

10: A method for manufacturing an optical member for terahertz, comprising:
a first process of mixing an organic nonlinear optical material and an excipient to form a mixture; and
a second process of forming a molded body of the mixture by applying a pressure to the mixture after the first process.

11: The method for manufacturing an optical member according to claim 10, further comprising:
a third process of crystallizing at least a part of the organic nonlinear optical material before the first process.
